(19) United States
(12) Patent Application Publication
(10) Pub. No.: US 2025/0358743 A1
(43) Pub. Date: Nov. 20, 2025

(54) NETWORK ASSISTED POWER SAVING AT A USER EQUIPMENT

(71) Applicant: Rakuten Mobile, Inc., Tokyo (JP)

(72) Inventors: Sumanmishra PRABHAT, Tokyo (JP); Akarsh SRIVASTAVA, Karnataka (IN); Manmeet Singh BHANGU, Karnataka (IN)

(73) Assignee: Rakuten Mobile, Inc., Tokyo (JP)

(21) Appl. No.: 19/093,528

(22) Filed: Mar. 28, 2025

(30) Foreign Application Priority Data
May 17, 2024 (IN) 202411038860
Aug. 29, 2024 (IN) 202411038860

(51) Int. Cl. H04W 52/02; H04L 65/1016; H04W 76/20

(52) U.S. Cl. CPC H04W 52/0277; H04L 65/1016; H04W 76/20

(57) ABSTRACT

Disclosed herein is an apparatus (108) configured to receive, from a User Equipment (UE) (102), a first indication corresponding to a first threshold battery level associated with the UE (102). Further, the apparatus (108) is configured to modify, based on the received first indication, one or more configurations associated with one or more applications or services of the UE (102) and reduce the corresponding signalling information. Further, the apparatus (108) is configured to receive, from the UE (102), a second indication corresponding to a second threshold battery level associated with the UE (102). Furthermore, the apparatus (108) is configured to selectively enable and disable the one or more applications or services and reduce the corresponding signalling information based on the received second indication.

### CROSS-REFERENCE TO RELATED APPLICATION(S)

This application claims priority to India Provisional Application No. 202411038860, filed on May 17, 2024, and India Non-Provisional application No. 202411038860, filed on Aug. 29, 2024, the entire contents of which are incorporated herein by reference.

### TECHNICAL FIELD

The present disclosure relates to network-assisted power saving at a User Equipment (UE).

### BACKGROUND

The information disclosed in this background section is only for enhancement of understanding of the general background of the disclosure and should not be taken as an acknowledgement or any form of suggestion that this information forms the prior art already known to a person skilled in the art.

In the existing communication networks (such as a 5G network), a User Equipment (UE) connected to a communication network may obtain a plurality of services from the communication network. The services may include data services, IP Multimedia Subsystem (IMS) services, and emergency services. The UE may also concurrently execute various applications and related functionalities installed on the UE. The obtained plurality of services and execution of the various applications on the UE increase the depletion of power at the UE. The UE usually obtains power from a size-constrained battery for the functioning of the UE.

The rapid depletion of power may result in a frequent need to recharge the battery of the UE. UE such as a smartphone or a smartwatch is used for both multimedia services and emergency services. Low power levels to support the functionality of the UE may result in the interruption of services. Further, emergency services such as healthcare services or disaster notifications may be unavailable due to insufficiency of power in the UE. A significant power consumption in the UE is associated with running services (e.g., IMS services) and obtaining signals from the network entities.

Thus, there is a need to provide a methodology to overcome the above-mentioned issues in the conventional techniques and ensure power saving at the UE.

### SUMMARY

This summary is provided to introduce a selection of concepts, in a simplified format, that are further described in the detailed description of the disclosure. This summary is neither intended to identify key or essential inventive concepts of the disclosure nor is it intended to determine the scope of the disclosure.

According to one embodiment of the present disclosure, an apparatus is disclosed. The apparatus is configured to receive, from a User Equipment (UE), a first indication corresponding to a first threshold battery level associated with the UE. Further, the apparatus is configured to modify one or more configurations associated with one or more applications or services of the UE and reduce the corresponding signalling information. The one or more configurations are modified based on the received first indication. Further, the apparatus is configured to receive, from the UE, a second indication corresponding to a second threshold battery level associated with the UE. Furthermore, the apparatus is configured to selectively enable and disable the one or more applications or services and reduce the corresponding signalling information based on the received second indication.

According to one embodiment of the present disclosure, a method is disclosed. The method includes receiving, by a core network entity, a first indication corresponding to a first threshold battery level associated with a User Equipment (UE), from the UE. Further, the method comprises modifying, by the core network entity, one or more configurations associated with one or more applications or services of the UE and reduce the corresponding signalling information. The one or more configurations are modified based on the received first indication. Further, the method comprises receiving, by the core network entity, a second indication corresponding to a second threshold battery level associated with the UE, from the UE. Furthermore, the method comprises selectively enabling and disabling, by the core network entity, the one or more applications or services, and reduce the corresponding signalling information based on the received second indication.

According to another embodiment of the present disclosure, a non-transitory computer-readable medium is disclosed. The non-transitory computer-readable medium stores instructions. The instructions comprise one or more instructions that are executed by a core network entity. The core network entity comprises one or more processors. The one or more instructions cause the one or more processors to receive, from a User Equipment (UE), a first indication corresponding to a first threshold battery level associated with the UE. Further, the one or more instructions cause the one or more processors to modify one or more configurations associated with one or more applications or services of the UE and reduce the corresponding signalling information. The one or more configurations are modified based on the received first indication. Further, the one or more instructions cause the one or more processors to receive, from the UE, a second indication corresponding to a second threshold battery level associated with the UE. Furthermore, the one or more instructions cause the one or more processors to selectively enable and disable the one or more applications or services and reduce the corresponding signalling information based on the received second indication.

The disclosed apparatus and method enable the continuous availability of emergency services at the UE by implementing network-assisted power saving at the UE. The periodic reporting of power levels at the UE based on predetermined threshold battery levels enables network-assisted power saving. The disclosure modifies configuration at the UE associated with applications and services based on a first threshold battery level. Further, the disclosure disables battery-intensive applications and services at the UE when the battery level falls below a critical level to ensure continuous availability of emergency services.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF FIGURES

Features, aspects, and advantages of certain exemplary embodiments of the disclosure will be described below with reference to the accompanying drawings, in which like reference numerals denote like elements, and wherein:

FIG. 1 illustrates an example block diagram of a communication environment depicting a User Equipment (UE) and a network operator, in accordance with an embodiment of the present disclosure;

FIG. 2 illustrates a block diagram of the UE, in accordance with an embodiment of the present disclosure;

FIG. 3 illustrates a block diagram of the 5G architecture and Network Functions (NFs), in accordance with an embodiment of the present disclosure;

FIG. 4A illustrates a signalling diagram for network-assisted power saving at the UE, in accordance with an embodiment of the present disclosure;

FIG. 4B illustrates a signalling diagram for network-assisted power saving at the UE, in accordance with another embodiment of the present disclosure;

FIG. 5A and FIG. 5B illustrates a signalling diagram for modifying configuration of one or more applications or services of the UE, in accordance with an embodiment of the present disclosure;

FIG. 6 illustrates a process flow depicting a method for implementing network-assisted power saving at the UE, in accordance with an embodiment of the present disclosure; and

FIG. 7 illustrates an exemplary embodiment of a device, in accordance with an embodiment of the present disclosure.

### DETAILED DESCRIPTION

The following detailed description of example embodiments refers to the accompanying drawings. The foregoing disclosure provides illustration and description but is not intended to be exhaustive or to limit the implementations to the precise form disclosed. Modifications and variations are possible in light of the above disclosure or may be acquired from the practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behaviour of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from the practice of the implementations.

Now exemplary embodiments of the present disclosure will be described below in detail with reference to the accompanying drawings.

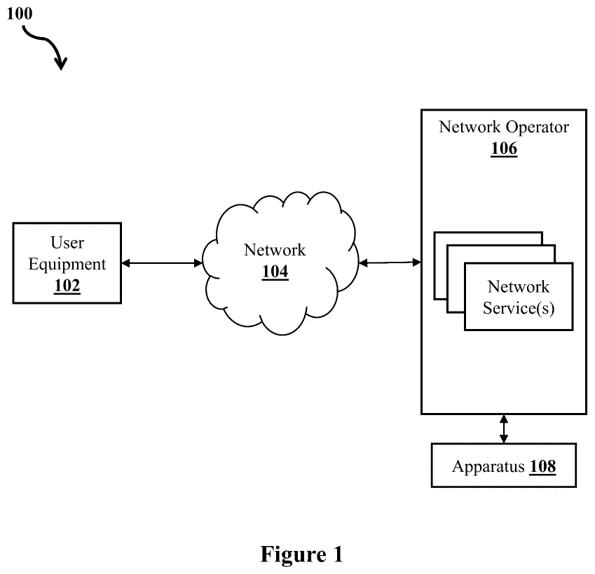

FIG. 1 illustrates an example block diagram of a communication environment 100 depicting a User Equipment (UE) 102 and a network operator 106, in accordance with an embodiment of the present disclosure. The network operator 106 provides a plurality of network services to the UE 102 via a network 104. The network operator 106 may be associated with an apparatus 108. The apparatus 108 may corresponds to a core network entity. The core network entity may be associated with a 5G system. In one non-limiting embodiment, the core network entity may correspond to a Policy Control Function (PCF).

The plurality of network services includes, but are not limited to, data services, IMS services, emergency services, and various other application-related functionalities implemented at the UE 102. The UE 102 may correspond to a subscriber of the network 104 and/or the network operator 106. The UE 102 may include, but is not limited to, a smartphone device, a tablet, a laptop, and so forth. The network operator 106 may be configured to monitor and optimize battery consumption at the UE 102 to provide optimized battery management and ensure service continuity. In an embodiment, the network operator 106 may be configured to adjust and/or modify one or more of the network services based on a battery level of the UE 102 to provide longer battery life to the UE 102 and ensure longer service continuity. The network operator 106 may also ensure connectivity to emergency services during low battery conditions at the UE 102. In some embodiments, the network operator 106 may collaborate with institutes and/or facilities such as, but not limited to, child-care facilities, aged care facilities, and/or with a subscriber of the UE to provide a tailored and/or modified service when a battery level of the corresponding UE(s) falls below a predefined threshold level. In one embodiment, the network operator 106 may selectively enable and/or disable certain applications and/or functionalities at the UE 102. For instance, the network operator 106 may change an Internet Protocol (IP) Multimedia Subsystem (IMS) video call to an audio call based on a battery level of the UE 102. In some embodiments, when the battery level of the UE 102 is below a critical threshold value, the network operator 106 may prioritize and maintain only essential services such as, but are not limited to, health monitoring applications (apps), emergency calling services, and so forth. This ensures the subscriber gets longer usage period for the essential services during low battery conditions.

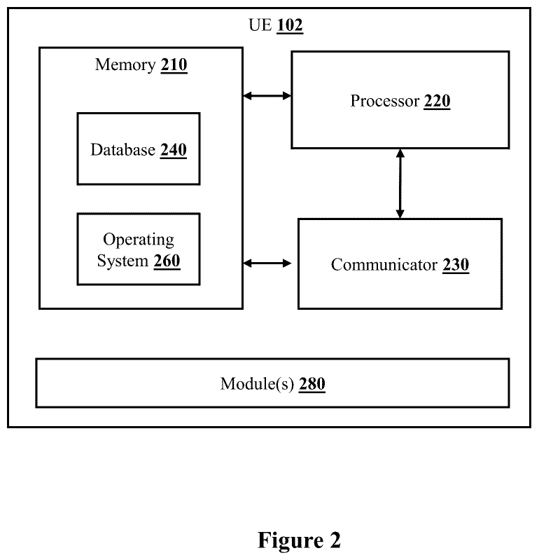

FIG. 2 illustrates a block diagram of the UE 102, in accordance with an embodiment of the present disclosure. In one or more embodiments, the UE 102 may include a memory 210, a processor 220, a communicator 230, and one or more module(s) 280.

In an embodiment, the memory 210 stores instructions to be executed by the processor 220 for implementing network-assisted power saving at the UE 102, as discussed throughout the disclosure. The memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted that the memory 210 is non-movable. In some examples, the memory 210 can be configured to store larger amounts of information than the memory. In certain examples, a non-transitory storage medium may store data that can, over time, change (e.g., in Random Access Memory (RAM) or cache). The memory 210 can be an internal storage unit, or it can be an external storage unit of the UE 102, a cloud storage, or any other type of external storage. The memory 210 may further include a database 240 to store the data. Further, the memory 210 may include an operating system 260 for performing one or more tasks of the UE 102, as performed by a generic operating system in the communications domain.

The processor 220 communicates with the memory 210 and the communicator 230. The processor 220 is configured to execute instructions stored in the memory 210 and to perform various processes for modifying one or more configurations at the UE 102, as discussed throughout the disclosure. The processor 220 may include one or a plurality of processors, may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI dedicated processor such as a Neural Processing Unit (NPU).

The communicator 230 is configured for communicating internally between internal hardware components and with external devices (e.g., the apparatus 108, or another UE 102) via one or more networks (e.g., radio technology). The communicator 230 includes an electronic circuit specific to a standard that enables wired or wireless communication.

The one or more modules 280 may be configured to implement one or more functionalities of the processor 220 and/or the UE 102. The modules 280, amongst other things, include routines, programs, objects, components, data structures, etc., which perform particular tasks or implement data types. The modules 280 may also be implemented as, signal processor(s), state machine(s), logic circuitries, and/or any other device or component that manipulates signals based on operational instructions. In some embodiments, the modules 280 may be implemented as dedicated hardware units. In some other embodiments, the modules 280 may be implemented in the form of virtualized software units in hardware or cloud environments.

Hereinafter, it is understood that terms including “unit” or “module” at the end may refer to the unit for processing at least one function or operation and may be implemented in hardware, software, or a combination of hardware and software.

In one embodiment, the UE 102 may be configured to periodically report an associated battery level to the apparatus 108 (i.e., the core network entity). In a scenario, where the battery level decreases substantially but is above a critical level, the apparatus 108 may modify the services and reduce the signalling information. This may reduce the battery consumption at the UE 102. For instance, for a reported battery level of 40%, the apparatus 108 may modify the configuration of an IMS video call for the UE 102 by enabling energy-efficient codecs and reducing the corresponding signalling information for the IMS video call.

In another example, for a reported battery level of 30%, the apparatus 108 may modify the configuration of an IMS video call for the UE 102 to an audio call. This may further reduce the corresponding signalling information. The reduced signalling information is associated with a requirement of an audio call as compared to the IMS video call. This ensures network-assisted power saving at the UE 102 as the signalling information and associated processing required at the UE 102 is significantly reduced compared to the IMS video call.

Furthermore, in a scenario where the battery level decreases to a critical level, the apparatus 108 may selectively enable and disable the services and reduce the signalling information. For instance, for a reported battery level of 10%, the apparatus may disable power consumption intensive services and applications (e.g., the IMS video call). Thus, the associated signalling information and processing required at UE 102 is reduced. This ensures network-assisted power saving at the UE 102 and an availability of essential applications and services (e.g., health care applications, and emergency services).

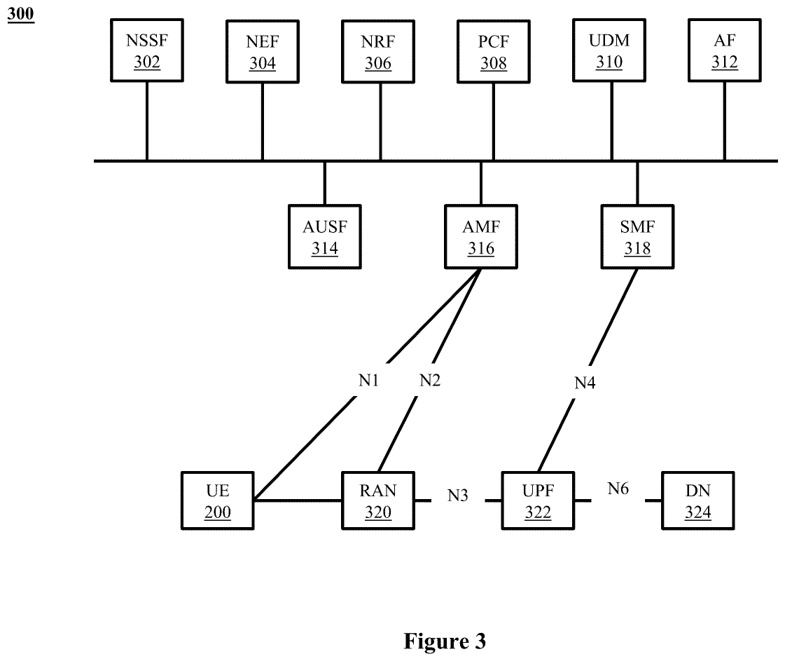

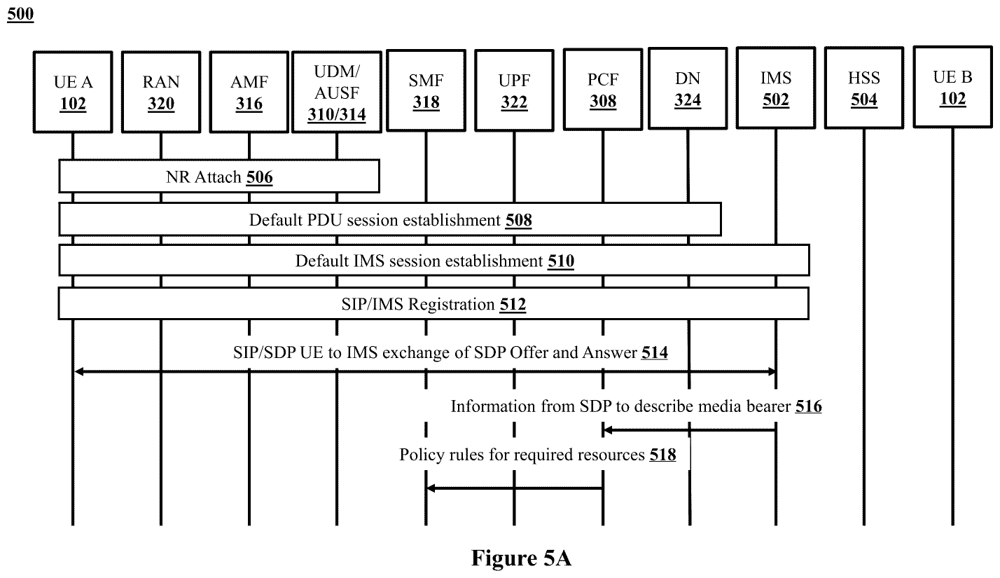

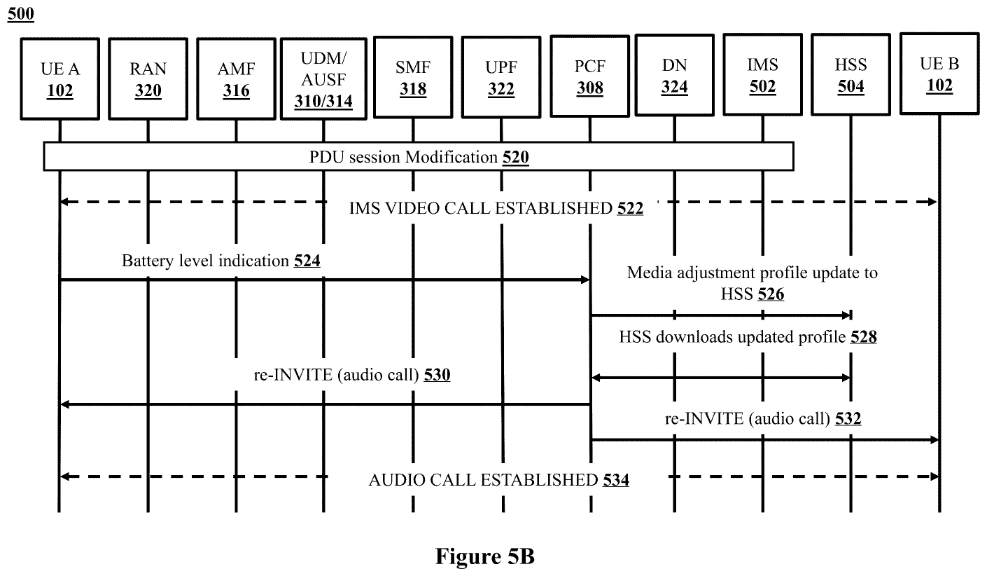

FIG. 3 illustrates a block diagram of the 5G architecture and Network Functions (NFs), in accordance with an embodiment of the present disclosure. The FIG. 3 illustrates a simplified 5G architecture without depicting all possible network functions and service-based interfaces. As illustrated in the FIG. 3, the UE 102 may be disposed in communication with a Radio Access Network (RAN) 320 as well as one or more 5G Core (5GC) network entities. The 5G architecture includes a plurality of network functions (NFs) as illustrated in the FIG. 5.

The NFs may include, but not limited to, an Access and Mobility Management Function (AMF) 316, a Session Management Function (SMF) 318, a Policy Control Function (PCF) 308, an Application Function (AF) 312, a User Plane Function (UPF) 322, a Network Slice Selection Function (NSSF) 302, an Authentication Server Function (AUSF) 314, a Unified Data Management (UDM) 310. Further, the 5G architecture in some embodiments may include a Network Exposure Function (NEF) 304 and a Network Repository Function (NRF) 306. In some embodiments, the NFs may act as the core network entities of the 5G system.

In some embodiments, the 5G architecture may include an IP Multimedia Subsystem (IMS) as well as a plurality of IP multimedia core network subsystem entities. The IMS and associated entities are not depicted in the figure for the sake of brevity. Further, some IP multimedia core network subsystem entities may be connected to a different IP multimedia network (e.g., an IMS operated by a different network operator). In some embodiments, the UDM 310 may correspond to a Home Subscriber Server (HSS) of a 4G communication system. The UDM 310 or HSS may be connected to an application such as a Telephony Application Server (TAS).

The UPF 322 may provide a connection to a Data Network (DN) 324 to support one or more network services. Examples of such network services may include, but not limited to, operator-supported services, internet access, or third-party services. The AMF 316 may be used to manage access control and mobility. The AMF 316 may also support network slice selection functionality. The SMF 318 may be configured to set up and manage various sessions according to network policy. The UPF 322 may be deployed in one or more configurations according to a desired service type. The PCF 308 may be configured to provide a policy framework using network slicing, mobility management, and roaming. The UDM 310 may be configured to store subscriber profiles and data (similar function as HSS in a 4G communication system).

The NFs and network entities may interact using interfaces, for example, the N3 interface illustrated between the RAN 320 and the UPF 322. Furthermore, authorized NFs can access the services associated with other NFs using service-based interfaces. The service-based interfaces are not depicted in the figure for the sake of clarity. The description provided for FIG. 3 may be used to understand the signalling flow illustrated in FIG. 5 of the present disclosure.

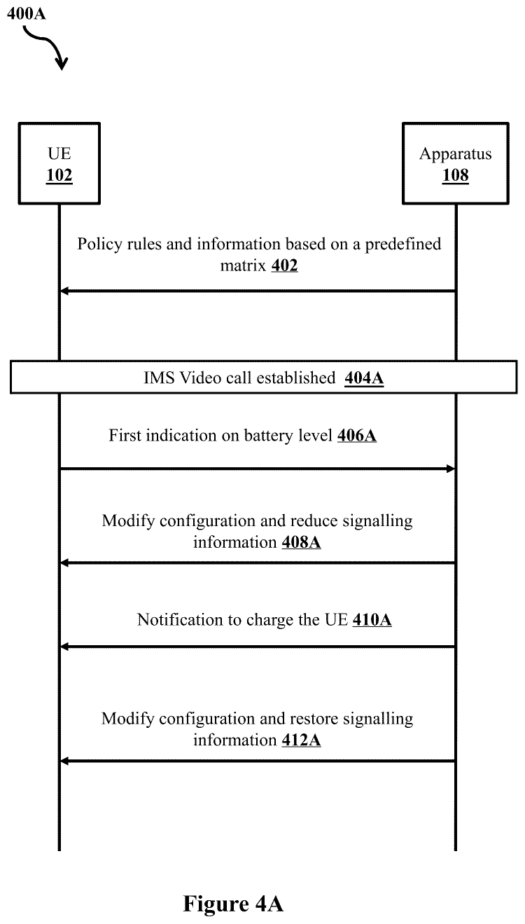

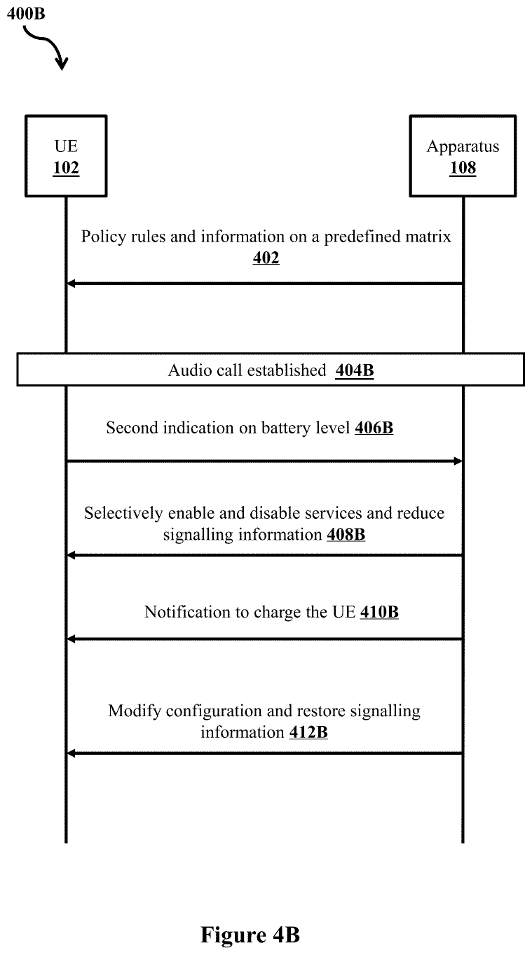

FIG. 4A illustrates a signalling diagram 400A for network-assisted power saving at the UE 102, in accordance with an embodiment of the present disclosure.

At step 402, the policy rules and information are exchanged between the UE 102 and apparatus 108. The policy rules and information may include configuration of services and applications and corresponding signalling information. In an example, the policy rules and information may include the details of energy-efficient codecs at the UE 102, Quality of Service (QoS) flow requirement for a service (e.g., IMS video call), and the like. In another example, the policy rules and information may include emergency services, healthcare applications and associated signalling requirements. In some embodiments, the policy rules and information may be on a predefined matrix. The predefined matrix may define a relation of the one or more battery thresholds and corresponding signalling configurations for the one or more applications/services. In a non-limiting embodiment, the predefined matrix may include a first threshold battery level and a second threshold battery level and associated signalling/modification configurations.

At step 404A, an IMS video call is established for the UE 102 by the apparatus 108. The apparatus 108 enables the establishment of the IMS video call in a communication environment such as 5G NR. The communication environment and a second UE associated with the IMS video call with UE 102 are not depicted for the sake of clarity. A detailed illustration is provided in FIG. 5 as an exemplary embodiment of the present disclosure.

At step 406A, the UE 102 may transmit a first indication corresponding to the first threshold battery level of the UE 102 to the apparatus 108.

At step 408A, the apparatus 108 may modify the configuration of one or more services or applications of the UE 102 based on the received first indication. In an example, the first indication may correspond to a battery level of the UE 102 as 30%. In response to the first indication, the apparatus 108 may enable a change of the IMS video call to an audio call. Thus, the apparatus 108 reduces the signalling information thereby ensuring network-assisted power saving at the UE 102.

At step 410A, the apparatus 108 may transmit a notification to the UE 102. The notification may alert the user to charge the UE 102.

At step 412A, on detecting the battery level above the first threshold, the apparatus modifies the configuration of one or more services to the initial configuration and restores the signalling information. In an example, the audio call is restored to the IMS video call and corresponding signalling information is also restored.

FIG. 4B illustrates a signalling diagram 400B for network-assisted power saving at the UE based on receiving a second indication associated with UE battery level, in accordance with an exemplary embodiment of the present disclosure. In one non-limiting embodiment, one or more steps as illustrated as a part of the signalling diagram 400B may be preceded by the steps of the signalling diagram 400A.

In the FIG. 4B, at step 402, the policy rules and information are exchanged between the UE 102 and apparatus 108. The explanation is provided in FIG. 4A and is not repeated herein for the sake of brevity.

At step 404B, an audio call established for the UE 100 by the apparatus 108. The apparatus 108 enables the establishment of the audio call in the communication environment such as the 5G NR. The communication environment and the second UE in the IMS video call with UE 102 is not depicted for the sake of clarity.

At step 406B, the UE 102 may transmit a second indication corresponding to the second threshold battery level of the UE 102 to the apparatus 108.

At step 408B, based on the received second indication, the apparatus 108 modifies the configuration of one or more services or applications of the UE 102. In an example, the second indication may correspond to 10% battery remaining at the UE 102. In response to the second indication, the apparatus 108 may disable the audio call, and enable only emergency services. The apparatus 108 further reduces the signalling information thereby ensuring longer battery life of the UE 102. In an example, the step 406B, may be followed by the apparatus 108 transmitting a notification to the UE 102. The notification may be associated with requesting a consent from a user of the UE 108. The consent is requested for disabling battery consumption intensive applications. The consent is further requested for enabling emergency services at the UE 108.

At step 410B, a notification may be sent to the UE 102 from the apparatus 108. The notification may be intended to alert the user of the UE 102 to charge the UE 102.

At step 412B, on detecting the battery level above the second threshold, the apparatus modifies the configuration of one or more services to the initial configuration and restores the signalling information. In an example, the audio call is restored, and corresponding signalling information is also restored. In the example, the UE 102 may transmit an indication corresponding to the first indication on detecting battery level above the second threshold. Further, as the battery level at the UE is below the first threshold, the IMS video call may not be supported for the UE 102 by the apparatus 108.

FIG. 5 illustrates a signalling diagram 500 for modifying the configuration of one or more applications or services of the UE 102 and reducing the corresponding signalling information, in accordance with an exemplary embodiment of the present disclosure.

The figure illustrates an exemplary embodiment where the UE A and UE B are the two UEs 102 trying to establish an IMS video call. The embodiment illustrates the modifications in the configuration of the one or more services and applications at the UE A. The FIG. 5 further illustrates the reduction in signalling information from the network towards the UE A. The reduction in signalling information is associated with power saving at the UE A. The reduced signalling information results in reduced processing and reception of signals from the network entities and ensures power saving at the UE A.

The network entities illustrated in the figure have been explained in the description for FIG. 3 of the present disclosure. Further, a serving Telephony Application Server (TAS) node in the IMS 502 may be configured to perform the steps depicted to be performed by the IMS 502 in FIG. 5.

At step 506, an NR attach procedure is performed by the UE for the initial registration of UE A with the network.

At step 508, a default Packet Data Unit (PDU) session establishment procedure is performed to establish a data path between the UE A and the Core Network (CN). The CN may correspond to the 5G network and different CN entities (e.g., SMF, PCF) as illustrated in FIG. 5.

At step 510, a default IMS session establishment session procedure is performed to set up a multimedia communication path between two or more parties (e.g., UE A and UE B) over an IP network. The IMS services may include Voice over IP (VOIP), IMS video call and conferencing, multimedia messaging, and the like.

At step 512, a Session Initiation Protocol (SIP) registration is performed to initiate a video call session through the IMS 502.

At step 514, a Session Description Protocol (SDP) message exchange is performed between the UE A and the IMS 502. The SDP message is associated with an exchange of a SDP offer and an answer message between the UE A and IMS 502. In an example, the SDP message may consist of a description of a media bearer, IP address of devices and ports involved in the SDP message exchange, codecs supported by the UE 102, bandwidth of the network channel, and the like.

At step 516, an information describing the media bearer is shared by the IMS 502 with the PCF 308.

At step 518, policy rules are shared by the PCF 308 with the SMF 318. The policy rules shared are associated with the resources required for the IMS video call requested by UE A. In an example, the resources required for the IMS video call may be based on parameters such as, but not limited to, Guaranteed Flow Bit Rate (GFBR), Quality of Services (QoS) flow rate (e.g., 40 Kbps), IP addresses of the devices involved in the IMS video call (UE A and UE B), and the like.

At step 520, a PDU session modification procedure is performed to create dedicated QoS flows for the UE A requesting the IMS video call.

At step 522, an IMS video call is established between UE A and UE B. The steps 506 to 522 describe the IMS video call establishment flow. In the subsequent steps the FIG. 5, illustrates the changes in the signalling flow associated with reception of battery level indication from the UE A.

At step 524, a battery level indication is transmitted by the UE A to the PCF 308. The PCF 308 based on the received battery level indication identifies if the battery level indication is a first indication or a second indication. As illustrated, the battery level indication may correspond to the first indication (or the first threshold battery level).

In the FIG. 5, the battery level indication is depicted to be transmitted directly to the PCF 308. In another embodiments, the battery level indication may be transmitted to the PCF 308 via one or more network entities. For example, the battery level indication may be first transmitted to the RAN 320, then to the AMF 316, then to the SMF 318, and thereafter to the PCF 308.

The PCF 308 determines that the battery level indication corresponds to the first threshold battery level. Based on the determination, the PCF 308 requests the HSS 504 to update the stored UE profile. The UE profile is updated based on the first threshold battery level. The configuration of services of the UE 102 is modified and signalling is reduced based on the modified services. The following steps illustrate the modification of service to an audio call and the associated reduction in the signalling information.

At step 526, the PCF 308 sends a media adjustment profile update message to the HSS 504. The HSS 504 downloads the updated profile and updates the records associated with UE A 102 to the updated profile.

At step 528, the HSS 504 sends an updated profile of the UE A 102 to the IMS 502 and the PCF 308. The IMS 502 based on the updated profile of the UE A 102 downgrades the IMS call configuration from the IMS video call to an audio call. The update related to the downgrade is communicated to the PCF 308.

At step 530, a re-INVITE message for an audio call session is transmitted to the UE A 102 by the PCF 308.

At step 532, another re-INVITE message for the audio call session is transmitted from the PCF 308 to the UE B 102.

At step 534, an audio call session is established between the UE A 102 and the UE B 102.

The signalling flow in FIG. 5 may be used to understand different scenarios associated with the present disclosure. For instance, in case the UE A battery level is below the first threshold battery level prior to a request for an IMS video call is made. In such a scenario, the network will disallow the request for an IMS video call. The service configuration to the UE A is modified to an audio call and signalling information is reduced to support the audio call.

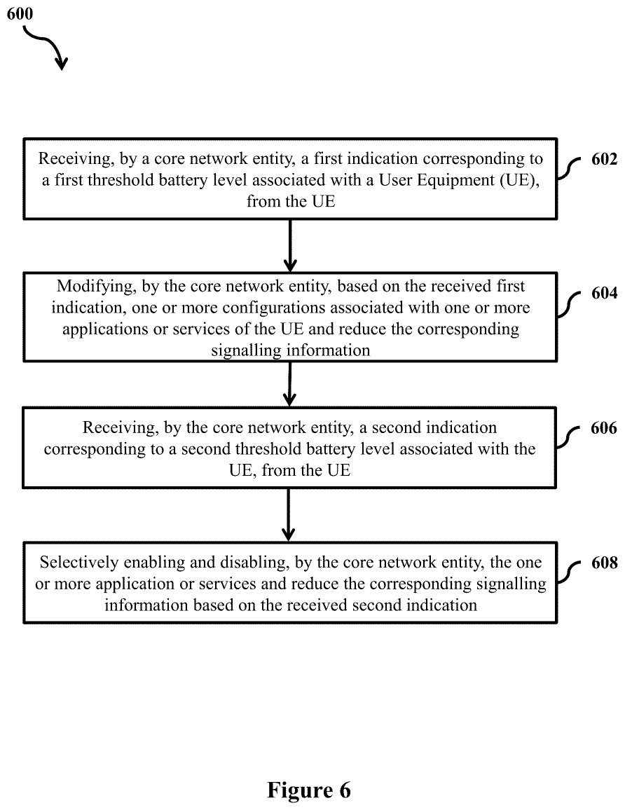

FIG. 6 illustrates a process flow depicting a method 600 for implementing network-assisted power saving at the UE 102, in accordance with an exemplary embodiment of the present disclosure.

At step 602, the method 600 may include receiving, by a core network entity, a first indication corresponding to a first threshold battery level associated with the UE 102, from the UE 102. In an example, the core network entity may correspond to the PCF 308.

At step 604, the method 600 may include modifying, by the core network entity, based on the received first indication, one or more configurations associated with one or more applications or services of the UE 102. The method 600 may further include reducing the corresponding signalling information to the UE 102. The reduction in signalling information is associated with power saving at the UE 102.

In an embodiment, modifying the one or more configurations associated with the one or more applications or services may include enabling energy-efficient codecs at the UE 102. In another embodiment, modifying the one or more configurations associated with the one or more applications or services may include modifying an IMS video-enabled call configuration to an audio call configuration based on the first received indication. An example of modifying configuration associated with one or more services or applications of the UE 102 is illustrated in FIG. 5.

At step 606, the method 600 includes receiving, by the core network entity, a second indication corresponding to a second threshold battery level associated with the UE 102, from the UE 102.

At step 608, the method 600 may include selectively enabling and disabling, by the core network entity, the one or more application or services. The method may further include reducing the corresponding signalling information based on the received second indication.

In the exemplary embodiment, selectively enabling or disabling the one or more applications or services may include disabling a plurality of battery consumption intensive applications or services among the one or more applications or services. In an example, the plurality of battery consumption intensive applications or services includes IMS video call applications or services, and audio call applications or services.

Further in the exemplary embodiment, selectively enabling or disabling the one or more applications or services may include enabling a plurality of essential applications or services among the one or more applications or services based on the received second indication. In an example, the plurality of essential applications or services includes emergency services, health care applications, and disaster warning notifications.

In an exemplary embodiment, the core network entity may receive at least one of UE assistance information or a Non-Access Stratum (NAS) message. The received message may include one of the first indication or the second indication corresponding to the battery level of the UE 102. In an example, the apparatus 108 receives a NAS message containing the second indication corresponding to the battery level of the UE 102.

In some embodiments of the present disclosure, prior to step 602, the method may include transmitting by the apparatus 108 one or more policies to configure the UE 102. The one or more policies configure the UE 102 to transmit the first indication based on a predefined matrix. Further, the predefined matrix may include one or more predefined threshold battery levels of the UE 102. In an example, the one or more predefined threshold battery levels in the predefined matrix may include 30%, 20%, 10%, and 5% as the remaining battery level of the UE 102. The one or more policies may include are associated with the predefined threshold battery levels. The one or more policies may further include the modifications in the one or more configurations of the one or more services (or applications) of the UE 102.

In some embodiments, the method 600 may further include periodically receiving at the apparatus 108 the first indication or the second indication. The periodic reception at the apparatus 108 may be based on the predefined matrix associated with a plurality of threshold battery levels at the UE 102. The plurality of threshold battery levels of the UE 102 may correspond to the first threshold and the second threshold. In an example, the first threshold battery level may be 30% and 10% as the remaining battery level of the UE 102.

In some embodiments, the method 600 may further include transmitting a visual notification from the apparatus 108 to the UE 102. The visual notification may indicate a requirement of charging the UE 102.

In an exemplary embodiment, the method 600 may further include receiving by the apparatus 108 a charging indication indicating the UE 102 is in a charging mode. In an alternate scenario, the method may also include receiving by the apparatus 108 a battery level indication. The battery level indication may indicate that the battery level of the UE is above at least one of the second threshold battery level or the first threshold battery level.

In case the battery level indication is above the first threshold, the method 600 may furthermore include modifying one or more configurations associated with one or more applications or services of the UE 102 to initial configurations by the apparatus 108. In case the battery level indication is above the second threshold the method 600 may include enabling each of the one or more applications or services associated with the UE.

While the above-discussed steps in FIG. 6 are shown and described in a particular sequence, the steps may occur in variations to the sequence in accordance with various exemplary embodiments.

Further, the present disclosure also describes non-transitory computer program products (i.e., physically embodies computer program products) or non-transitory computer-readable mediums encoded with executable instructions that store instructions. The executable instructions, when executed by one or more processors, such as the processor 220, cause the one or more processors to perform a method for performing network-assisted power saving at the UE as described in the present disclosure, as elaborated in the preceding paragraphs. Examples of computer-readable mediums include non-volatile, hard-coded type mediums such as read-only memories (ROMs) or erasable, electrically programmable read-only memories (EEPROMs), and user-recordable type mediums such as floppy disks, hard disk drives and compact disk read-only memories (CD-ROMs) or digital versatile disks (DVDs).

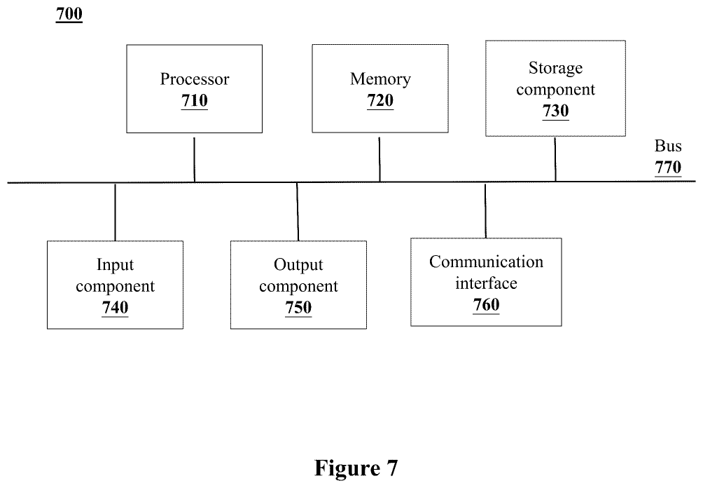

FIG. 7 illustrates an exemplary embodiment of a device 700 associated with apparatus 108 and UE 102. As shown in FIG. 7, the device 700 includes a processor 710 (for instance, analogous to processor 220), a memory 720 (for instance, analogous to memory 210), a storage component 730, an input component 740, an output component 750, a communication interface 760 (for instance, analogous to the communicator 230), and a bus 770.

The processor 710, as used herein, means any type of computational circuit that may comprise hardware elements and software elements. The processor 710 may be embodied as a multi-core processor, a single core processor, or a combination of one or more multi-core processors and/or one or more single core processors, a distributed processing system, or the like. The processor 710 may be a Central Processing Unit (CPU), a graphics processing unit (GPU), an accelerated processing unit (APU), an application-specific integrated circuit (ASIC), or another type of processing component.

The memory 720 includes a non-transitory computer readable medium. The memory 720 includes a random-access memory (RAM), a read only memory (ROM), and/or another type of dynamic or static storage device (e.g., a flash memory, a magnetic memory, and/or an optical memory) that stores information and/or instructions for use by the processor 710. The memory 720 comprises machine-readable instructions which are executable by the processor 710. These machine-readable instructions when executed by the processor 710 cause the processor 710 to perform one or more method steps of an exemplary embodiment described in the present disclosure.

The storage component 730 stores information and/or software related to the operation and use of the device 700. For example, the storage component 730 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 740 is configured to receive information, such as user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a global positioning system (GPS), an accelerometer, a gyroscope, and/or an actuator).

The output component 750 is configured to provide output information from the device 700. For example, the output component 750 may be, but not limited to, a display, a speaker, instructions to an external device, and/or one or more light-emitting diodes (LEDs).

The communication interface 760 is an interface that provides a communication connection to other devices, such as external devices and internal devices. The connection by the communication interface 760 can be a wired connection, a wireless connection, or a combination of wired and wireless connections, and can be a direct connection or an indirect connection via a communication network that exists between the device 700 and other devices. In other words, the standard of the communication interface 760 is not limited.

The bus 770 acts as an interconnect between the processor 710, the memory 720, the storage component 730, the input component 740, the output component 750, and the communication interface 760 of the device 700. The bus 770 may include a wired interconnection or a wireless interconnection.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700. Further, one or more method steps described in any of the exemplary embodiments may be performed utilizing a plurality of devices 700 in communication with one another.

An apparatus configured to receive, from a User Equipment (UE), a first indication corresponding to a first threshold battery level associated with the UE. Further, the apparatus is configured to modify, based on the received first indication, one or more configurations associated with one or more applications or services of the UE and reduce the corresponding signalling information. Further, the apparatus is configured to receive, from the UE, a second indication corresponding to a second threshold battery level associated with the UE. Furthermore, the apparatus is configured to selectively enable and disable the one or more application or services and reduce the corresponding signalling information based on the received second indication.

The apparatus as described in [0096], wherein the apparatus is configured to receive, from the UE, one of a UE assistance information or a Non-Access Stratum (NAS) message including one of the first indication or the second indication corresponding to the battery level of the UE.

The apparatus as described in any of [0096] to [0097], wherein to modify the one or more configurations associated with the one or more applications or services, the apparatus is configured to enable energy efficient codecs at the UE. The apparatus may be further configured to modify an Internet Protocol (IP) Multimedia Subsystem (IMS) video enabled call configuration to an audio call configuration based on the first received indication.

The apparatus as described in any of [0096] to [0098], wherein to selectively enable or disable the one or more applications or services, the apparatus is configured to disable a plurality of battery consumption intensive applications or services among the one or more applications or services. The apparatus is further configured to enable a plurality of essential applications or services among the one or more applications or services based on the received second indication.

The apparatus as described in any of [0096] to [0099], wherein the plurality of battery consumption intensive applications or services comprises IMS video call applications or services, and the audio call applications or services. Further, wherein the plurality of essential applications or services comprises emergency services, health care applications, and disaster warning notifications.

The apparatus as described in any of [0096] to [0100], wherein the apparatus is configured to transmit, to the UE, one or more policies to configure the UE to transmit the first indication based on a predefined matrix including one or more predefined threshold battery levels. The apparatus transmits the one or more policies prior to receiving the first indication corresponding to the battery level associated with the UE.

The apparatus as described in any of [0096] to [0101], wherein the apparatus is configured to periodically receive the first indication or the second indication based on the predefined matrix including the one or more predefined threshold battery levels.

The apparatus as described in any of [0096] to [0102], wherein the apparatus is configured to transmit, in response to the received second indication, a visual notification to the UE. The visual notification indicates a requirement for charging the UE.

The apparatus as described in any of [0096] to [0103], wherein the apparatus is configured to receive, from the UE, at least one of a charging indication indicating the UE is in a charging mode. The apparatus is further configured to receive a battery level indication indicating the battery level of the UE is above at least one of the second threshold battery level or the first threshold battery level. Further, the apparatus is configured to modify one or more configurations associated with one or more applications or services of the UE to initial configurations. The modification is performed based on the received at least one of the charging indication or the battery level indication. The apparatus is further configured to enable each of the one or more applications or services associated with the UE.

The apparatus as described in any of [0096] to [0104], corresponds to a core network entity.

A method comprises receiving, by a core network entity, a first indication corresponding to a first threshold battery level associated with a User Equipment (UE), from the UE. Further, the method comprises modifying, by the core network entity, based on the received first indication, one or more configurations associated with one or more applications or services of the UE and reduce the corresponding signalling information. Further, the method comprises receiving, by the core network entity, a second indication corresponding to a second threshold battery level associated with the UE, from the UE. Furthermore, the method comprises selectively enabling and disabling, by the core network entity, the one or more application or services and reduce the corresponding signalling information based on the received second indication.

The method as described in [0106], wherein the method comprises receiving, by the core network entity one of a UE assistance information or a Non-Access Stratum (NAS) message including one of the first indication or the second indication corresponding to the battery level of the UE, from the UE.

The method as described in any of [0106] to [0107], wherein modifying the one or more configurations associated with the one or more applications or services comprises enabling, by the core network entity, energy efficient codecs at the UE. The method further comprises modifying, by the core network entity, an Internet Protocol (IP) Multimedia Subsystem (IMS) video enabled call configuration to an audio call configuration based on the first received indication.

The method as described in any of [0106] to [0108], wherein selectively enabling or disabling the one or more applications or services comprises disabling, by the core network entity, a plurality of battery consumption intensive applications or services among the one or more applications or services. The method further comprises enabling, by the core network entity, a plurality of essential applications or services among the one or more applications or services based on the received second indication.

The method as described in any of [0106] to [0109], wherein the plurality of battery consumption intensive applications or services comprises IMS video call applications or services, and the audio call applications or services. Further, wherein the plurality of essential applications or services comprises emergency services, health care applications, and disaster warning notifications.

The method as described in any of [0106] to [0110], wherein the method comprises transmitting, by the core network entity, one or more policies to configure the UE to transmit the first indication based on a predefined matrix including one or more predefined threshold battery levels, to the UE. The method comprises transmitting the one or more policies prior to receiving the first indication corresponding to the battery level associated with the UE.

The method as described in any of [0106] to [0111], wherein the method further comprises periodically receiving the first indication or the second indication based on the predefined matrix including the one or more predefined threshold battery levels.

The method as described in any of [0106] to [0112], wherein the method further comprises transmitting, by the core network entity, in response to the received second indication, a visual notification to the UE. The visual notification indicates a requirement for charging the UE.

The method as described in any of [0106] to [0113], wherein the method comprises receiving, by the core network entity, at least one of a charging indication indicating the UE is in a charging mode. The method further comprises receiving a battery level indication indicating the battery level of the UE is above at least one of the second threshold battery level or the first threshold battery level. Further, the method comprises modifying one or more configurations associated with one or more applications or services of the UE to initial configurations. The modification is performed based on the received at least one of the charging indication or the battery level indication. The method further comprises enabling each of the one or more applications or services associated with the UE.

A non-transitory computer-readable medium storing instructions, the instructions comprising one or more instructions. The instructions when executed by a core network entity comprising one or more processors, cause the one or more processors to receive, from a User Equipment (UE), a first indication corresponding to a first threshold battery level associated with the UE. Further, the instructions when executed causes the processor to modify, based on the received first indication, one or more configurations associated with one or more applications or services of the UE and reduce the corresponding signalling information. Further, the instructions when executed causes the processor to receive, from the UE, a second indication corresponding to a second threshold battery level associated with the UE. Furthermore, the instructions when executed causes the processor to selectively enable and disable the one or more application or services and reduce the corresponding signalling information based on the received second indication.

The embodiments disclosed herein can be implemented through at least one software program running on at least one hardware device and performing network management functions to control the elements. The elements can be at least one of a hardware device, or a combination of hardware devices and software modules.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. An apparatus configured to:
receive, from a User Equipment (UE), a first indication corresponding to a first threshold battery level associated with the UE;
modify, based on the received first indication, one or more configurations associated with one or more applications or services of the UE and reduce the corresponding signalling information;
receive, from the UE, a second indication corresponding to a second threshold battery level associated with the UE;
selectively enable and disable the one or more applications or services and reduce the corresponding signalling information based on the received second indication.

2. The apparatus of claim 1, wherein to receive the first indication and the second indication, the apparatus is configured to:
receive, from the UE, one of a UE assistance information or a Non-Access Stratum (NAS) message including one of the first indication or the second indication corresponding to the battery level of the UE.

3. The apparatus of claim 1, wherein to modify the one or more configurations associated with the one or more applications or services, the apparatus is configured to:
enable energy efficient codecs at the UE; or
modify an Internet Protocol (IP) Multimedia Subsystem (IMS) video enabled call configuration to an audio call configuration based on the first received indication.

4. The apparatus of claim 1, wherein to selectively enable or disable the one or more applications or services, the apparatus is configured to:
disable a plurality of battery consumption intensive applications or services among the one or more applications or services; and
enable a plurality of essential applications or services among the one or more applications or services based on the received second indication.

5. The apparatus of claim 4, wherein the plurality of battery consumption intensive applications or services comprises IMS video call applications or services, and the audio call applications or services, and wherein the plurality of essential applications or services comprises emergency services, health care applications, and disaster warning notifications.

6. The apparatus of claim 1, wherein prior to receive the first indication corresponding to the battery level associated with the UE, the apparatus is configured to:
transmit, to the UE, one or more policies to configure the UE to transmit the first indication based on a predefined matrix including one or more predefined threshold battery levels.

7. The apparatus of claim 1, wherein the apparatus is configured to:
periodically receive the first indication or the second indication based on the predefined matrix including the one or more predefined threshold battery levels.

8. The apparatus of claim 1, wherein the apparatus is configured to:
transmit, in response to the received second indication, a visual notification to the UE, wherein the visual notification indicates a requirement for charging the UE.

9. The apparatus of claim 1, wherein the apparatus is configured to:
receive, from the UE, at least one of:
a charging indication indicating the UE is in a charging mode; or
a battery level indication indicating the battery level of the UE is above at least one of the second threshold battery level or the first threshold battery level; and
perform, based on the received at least one of the charging indication or the battery level indication, at least one of:
modify one or more configurations associated with one or more applications or services of the UE to initial configurations; and
enable each of the one or more applications or services associated with the UE.

10. The apparatus of claim 1, corresponds to a core network entity.

11. A method comprising:
receiving, by a core network entity, a first indication corresponding to a first threshold battery level associated with a User Equipment (UE), from the UE;
modifying, by the core network entity, based on the received first indication, one or more configurations associated with one or more applications or services of the UE and reduce the corresponding signalling information;
receiving, by the core network entity, a second indication corresponding to a second threshold battery level associated with the UE, from the UE;
selectively enabling and disabling, by the core network entity, the one or more applications or services and reduce the corresponding signalling information based on the received second indication.

12. The method of claim 11, wherein for receiving the first indication and the second indication, the method comprises:
receiving, by the core network entity one of a UE assistance information or a Non-Access Stratum (NAS) message including one of the first indication or the second indication corresponding to the battery level of the UE, from the UE.

13. The method of claim 11, wherein modifying the one or more configurations associated with the one or more applications or services comprises:
enabling, by the core network entity, energy efficient codecs at the UE; or
modifying, by the core network entity, an Internet Protocol (IP) Multimedia Subsystem (IMS) video enabled call configuration to an audio call configuration based on the first received indication.

14. The method of claim 11, wherein selectively enabling or disabling the one or more applications or services comprises:
disabling, by the core network entity, a plurality of battery consumption intensive applications or services among the one or more applications or services; and
enabling, by the core network entity, a plurality of essential applications or services among the one or more applications or services based on the received second indication.

15. The method of claim 14, wherein the plurality of battery consumption intensive applications or services comprises IMS video call applications or services, and the audio call applications or services, and wherein the plurality of essential applications or services comprises emergency services, health care applications, and disaster warning notifications.

16. The method of claim 11, wherein prior to receiving the first indication corresponding to the battery level associated with the UE, the method comprises:
transmitting, by the core network entity, one or more policies to configure the UE to transmit the first indication based on a predefined matrix including one or more predefined threshold battery levels, to the UE.

17. The method of claim 11, further comprising:
periodically receiving the first indication or the second indication based on the predefined matrix including the one or more predefined threshold battery levels.

18. The method of claim 11, further comprising:
transmitting, by the core network entity, in response to the received second indication, a visual notification to the UE, wherein the visual notification indicates a requirement for charging the UE.

19. The method of claim 11, further comprises:
receiving, by the core network entity, at least one of:
a charging indication indicating the UE is in a charging mode; or
a battery level indication indicating the battery level of the UE is above at least one of the second threshold battery level or the first threshold battery level; and
performing, by the core network entity, based on the received at least one of the charging indication or the battery level indication, at least one of:
modifying one or more configurations associated with one or more applications or services of the UE to initial configurations; and
enabling each of the one or more applications or services associated with the UE.

20. A non-transitory computer-readable medium storing instructions, the instructions comprising: one or more instructions that, when executed by a core network entity comprising one or more processors, cause the one or more processors to:
receive, from a User Equipment (UE), a first indication corresponding to a first threshold battery level associated with the UE;
modify, based on the received first indication, one or more configurations associated with one or more applications or services of the UE and reduce the corresponding signalling information;
receive, from the UE, a second indication corresponding to a second threshold battery level associated with the UE;
selectively enable and disable the one or more applications or services and reduce the corresponding signalling information based on the received second indication.
